(19) United States
(12) Patent Application Publication
(10) Pub. No.: US 2025/0383140 A1
(43) Pub. Date: Dec. 18, 2025

(54) REFRIGERATOR AND METHOD FOR CONTROLLING THE SAME

(71) Applicant: SAMSUNG ELECTRONICS CO., LTD., Suwon-si (KR)

(72) Inventors: Jongsoo HONG, Suwon-si (KR); Taegyoon Noh, Suwon-si (KR); Yongchan Kwon, Suwon-si (KR); Jihyun Ryu, Suwon-si (KR); Chunseong Kim, Suwon-si (KR); Dongseok Lee, Suwon-si (KR)

(73) Assignee: SAMSUNG ELECTRONICS CO., LTD., Suwon-si (KR)

(21) Appl. No.: 19/203,867

(22) Filed: May 9, 2025

Related U.S. Application Data
(63) Continuation of application No. PCT/KR2025/005541, filed on Apr. 24, 2025.

(30) Foreign Application Priority Data
Jun. 14, 2024 (KR) 10-2024-0077572

(51) Int. Cl. F25D 23/02; E05F 15/70

(52) U.S. Cl. CPC F25D 23/028; E05F 15/70; E05Y 2400/354; E05Y 2900/31; F25D 2700/02

(57) ABSTRACT

A home appliance may include a body; a door rotatably coupled to the body; a sensor configured to sense information about the door; and a processor configured to: based on the information sensed by the sensor, identify a state of the door, in response to the identified state of the door being a closed state, based on the information sensed by the sensor, obtain changes in a distance between the body and an inner surface of the door, based on the obtained changes in the distance, determine at least one of a first press count or a first press duration, based on the determined at least one first press count or first press duration, determine a first press pattern of the door, and perform control to provide a smart function of the home appliance corresponding to the determined first press pattern.

### CROSS-REFERENCE TO RELATED APPLICATIONS

This application is a continuation application of International Application No. PCT/KR2025/005541 designating the United States, filed on Apr. 24, 2025, in the Korean Intellectual Property Receiving Office, which claims priority from Korean Patent Application No. 10-2024-0077572, filed on Jun. 14, 2024, in the Korean Intellectual Property Office, the disclosures of which are hereby incorporated by reference herein in their entireties.

### BACKGROUND

### Field

The disclosure relates to a home appliance sensing a closed state of a door and an operating method thereof.

### Description of Related Art

In general, a refrigerator is a home appliance for storing food at low temperatures in an internal storage space shielded by a door. To that end, the refrigerator may be configured to store food in an optimal state by cooling the inside of the storage space using cold air generated through heat exchange with a refrigerant circulating in the freezing cycle.

Refrigerators are gradually becoming larger and/or multifunctional according to changes in diet or the trend of more demand for luxury products. Due to this trend, a structure or smart function that may lead to use convenience or efficient use of the internal space has been applied to the refrigerator.

The basic function of the refrigerator may be to efficiently maintain or manage the temperature of the storage space inside. Opening and closing of the door in the refrigerator may be one of the representative causes of changing the temperature of the storage space.

Therefore, it may be desirable to keep the door of the refrigerator closed without being opened to the outside as much as possible. To that end, a need exists for a method for sensing the state of the door and maintaining the temperature of the inside of the refrigerator according to the sensing results.

### SUMMARY

Various embodiments of the disclosure may provide a home appliance for sensing a separation distance between the main body and the door and identifying a press to the door based on the sensing result, and an operation method thereof.

In accordance with the present disclosure, a home appliance may include: a main body; a door rotatably coupled to the main body; a sensor configured to sense information about the door; and a processor configured to: based on the information sensed by the sensor, identify a state of the door, in response to the identified state of the door being a closed state in which the main body and the door substantially contact each other, based on the information sensed by the sensor, obtain changes in a distance between the main body and an inner surface of the door that faces the main body, based on the obtained changes in the distance, determine at least one of a first press count or a first press duration, based on the determined at least one first press count or first press duration, determine a first press pattern of the door, and perform control to provide a smart function of the home appliance corresponding to the determined first press pattern.

The processor may be further configured to: obtain a first number of times in which a sensing voltage level indicating the obtained changes in the distance reaches a first threshold for determining a press start, obtain a second number of times in which the sensing voltage level reaches a second threshold for determining a press release, obtain a press end in which the sensing voltage level reaches a third threshold for determining a final press release, and in response to the obtained press end, based on the obtained first number of times and the obtained second number of times, identify the first press count, and based on a time interval between a first time of the sensing voltage level reaching the first threshold and a second time of the sensing voltage level reaching the second threshold, identify the first press duration.

The sensor may include a reed switch configured to sense information about the door and produce information corresponding to the sensed information, and the processor may be further configured to: based on the information produced by the reed switch, identify the state of the door being an open state or the closed state.

The sensor may include an optical sensor configured to sense information about the door and produce information corresponding to the sensed information, and the processor may be further configured to: based on the information produced by the optical sensor, collect sensing data corresponding to the distance between the main body and the inner surface of the door, obtain a standard deviation of the collected sensing data, and set the first threshold and the second threshold based on the obtained standard deviation.

The sensor may include a pressure sensor configured to sense a pressure inside the main body and produce corresponding data, and the processor may be further configured to: based on the data produced by the pressure sensor, obtain a change in pressure inside the main body, based on the obtained change in pressure, determine at least one of a second press count or a second press duration, and based on the determined at least one second press count or second press duration, determine a second press pattern of the door, identify another smart function of the home appliance corresponding to the determined second press pattern, and perform control to provide the identified another smart function.

The processor may be further configured to: based on the information sensed by the sensor, identify a press start corresponding to a start of a press on an outer surface of the door, identify a press end corresponding to an end of the press on the outer surface, based on a standard deviation of the information sensed by the sensor, detect a final press corresponding to a final press on the outer surface, and based on the identified press start, the identified press end, and the detected final press, determine the first press count.

The processor may be further configured to: based on the information sensed by the sensor, identify a press start corresponding to a start of a press on an outer surface of the door, identify a press end corresponding to an end of the press on the outer surface, and based on the identified press start, the identified press end, determine the first press duration based on a time interval between a time of identifying the press start and a time of identifying the press end.

The sensor may include: an optical sensor configured to sense information about the door and produce first information corresponding to the information sensed by the optical sensor, and a reed switch configured to sense information about the door and produce second information corresponding to the information sensed by the reed switch, and the processor may be further configured to: based on the second information produced by the reed switch, identify the state of the door is the closed state, and in response to the identified state of the door being the closed state, based on the first information produced by the optical sensor, determine the state of the door is a tiny-open state.

The processor may be further configured to: identify whether the first information produced by the optical sensor corresponds to a level of the first information produced by the optical sensor with the state of the door being a normal closed state, and based on the first information produced by the optical sensor failing to reach the level, determine the state of the door is the tiny-open state.

The processor may be further configured to: collect the obtained changes in the distance for a predetermined time interval, calculate a standard deviation of the collected changes in the distance, and with the calculated standard deviation being valid, determine reference data for determining a press on an outer surface of the door based on the collected changes in the distance.

In accordance with the present disclosure, a method of operating a home appliance including a main body, a door rotatably coupled to the main body, a sensor configured to sense information about the door, and a processor, may include: by the processor, based on the information sensed by the sensor, identifying a state of the door, in response to the identified state of the door being a closed state in which the main body and the door substantially contact each other, based on the information sensed by the sensor, obtaining changes in a distance between a main body and an inner surface of the door that faces the main body, based on the obtained changes in the distance, determining at least one of a first press count or a first press duration, based on the determined at least one first press count or first press duration, determining a first press pattern of the door, identifying a smart function of the home appliance corresponding to the determined first press pattern, and performing control to provide the identified smart function.

The determining the first press pattern may include: obtaining a first number of times in which a sensing voltage level indicating the obtained changes in the distance reaches a first threshold for determining a press start; obtaining a second number of times in which the sensing voltage level reaches a second threshold for determining a press release, obtaining a press end in which the sensing voltage level reaches a third threshold for determining a final press release, and in response to the obtained press end, based on the obtained first number of times and the obtained second number of times, identifying the first press count, and based on a time interval between a first time of the sensing voltage level reaching the first threshold and a second time of the sensing voltage level reaching the second threshold, identifying the first press duration.

The sensor may include a reed switch configured to sense information about the door and produce information corresponding to the sensed information, and the identifying the state of the door may include: based on the information produced by the reed switch, identifying the state of the door being an open state or the closed state.

The sensor may include an optical sensor configured to sense information about the door and produce information corresponding to the sensed information, and the method may further include: by the processor, based on the information produced by the optical sensor, collecting sensing data corresponding to the distance between the main body and the inner surface of the door, obtaining a standard deviation of the collected sensing data, and setting the first threshold and the second threshold based on the obtained standard deviation.

The sensor may include a pressure sensor configured to sense a pressure inside the main body and produce corresponding data, and the method may further include: by the processor, based on the data produced by the pressure sensor, obtaining a change in pressure inside the main body, based on the obtained change in pressure, determining at least one of a second press count or a second press duration, based on the determined at least one second press count or second press duration, determining a second press pattern of the door, identifying another smart function of the home appliance corresponding to the determined second press pattern, and performing control to provide the identified another smart function.

The determining the first press pattern may include: by the processor, based on the information sensed by the sensor, identifying a press start corresponding to a start of a press on an outer surface of the door, identifying a press end corresponding to an end of the press on the outer surface, based on a standard deviation of the information sensed by the sensor, detecting a final press corresponding to a final press on the outer surface, and based on the identified press start, the identified press end, and the detected final press, determining the first press count.

The determining the first press pattern may include: by the processor, based on the information sensed by the sensor, identifying a press start corresponding to a start of a press on an outer surface of the door, identifying a press end corresponding to an end of the press on the outer surface, and based on the identified press start and the identified press end, determining the first press duration based on a time interval between a time of identifying the press start and a time of identifying the press end.

The sensor may include: an optical sensor configured to sense information about the door and produce first information corresponding to the information sensed by the optical sensor, and a reed switch configured to sense information about the door and produce second information corresponding to the information sensed by the reed switch, and the identifying the state of the door may include: based on the second information produced by the reed switch, identifying the state of the door is the closed state, and the method may further include: by the processor, in response to the identified state of the door based on the second information being the closed state, based on the first information produced by the optical sensor, determining the state of the door is a tiny-open state.

The determining the tiny-open state may include: identifying whether the first information produced by the optical sensor corresponds to a level of the first information produced by the optical sensor with the state of the door being a normal closed state, and based on the first information produced by the optical sensor failing to reach the level, determining the state of the door is the tiny-open state.

The method may further include: by the processor, collecting the obtained changes in the distance for a predetermined time interval, calculating a standard deviation of the collected changes in the distance, and with the calculated standard deviation being valid, determining reference data for determining a press on an outer surface of the door based on the collected changes in the distance.

According to various embodiments of the disclosure, as the home appliance performs a smart function by identifying whether there is a touch to the front surface of the door or a touch pattern, providing the user with user convenience.

The technical objects of the disclosure are not limited to the foregoing, and other technical objects may be derived by one of ordinary skill in the art from example embodiments of the disclosure.

Effects of the disclosure are not limited to the foregoing, and other unmentioned effects would be apparent to one of ordinary skill in the art from the following description. In other words, unintended effects in practicing embodiments of the disclosure may also be derived by one of ordinary skill in the art from example embodiments of the disclosure.

### BRIEF DESCRIPTION OF THE DRAWINGS

In connection with the description of the drawings, the same or similar reference numerals may be used to denote the same or similar elements.

FIG. 1 is a perspective view illustrating a refrigerator with a door closed according to an embodiment of the disclosure.

FIG. 2 is a perspective view illustrating a refrigerator with some doors opened, according to an embodiment of the disclosure.

FIG. 3 is a perspective view illustrating a refrigerator with all doors opened according to an embodiment of the disclosure.

FIG. 4A is a view illustrating an example of detecting a first state in which no press occurs in a refrigerator in a state in which a door is closed, according to an embodiment of the disclosure.

FIG. 4B is a view illustrating an example of detecting a second state in which a press occurs in a refrigerator in a state in which a door is closed, according to an embodiment of the disclosure.

FIG. 5 is a block view illustrating a refrigerator according to an embodiment of the disclosure.

FIG. 6 is a control flowchart for determining a push pattern in a refrigerator, according to an embodiment of the disclosure.

FIG. 7 is a control flowchart for determining tiny opening in a refrigerator according to an embodiment of the disclosure.

FIG. 8A is an example of a waveform view for identifying a press or press pattern to a door in a refrigerator according to an embodiment of the disclosure.

FIG. 8B is an example of a waveform diagram for identifying an open state of a door in a refrigerator according to an embodiment of the disclosure.

FIG. 8C is an example of a press pattern to a door in a refrigerator according to an embodiment of the disclosure.

FIG. 9 is a control flowchart for determining a push pattern in a refrigerator, according to an embodiment of the disclosure.

FIG. 10 is an example of an internal pressure change pattern for identifying a press or press pattern to a door in a refrigerator according to an embodiment of the disclosure.

### DETAILED DESCRIPTION

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

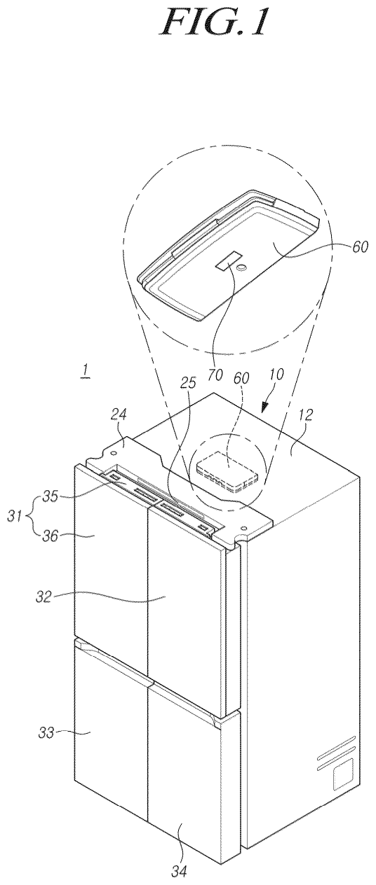

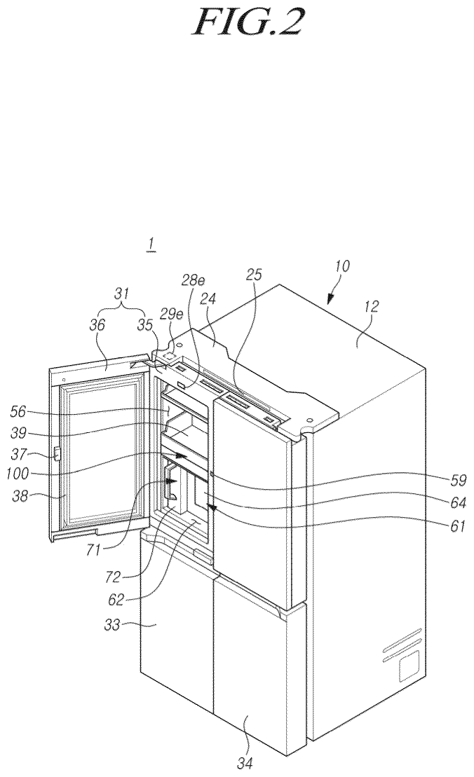

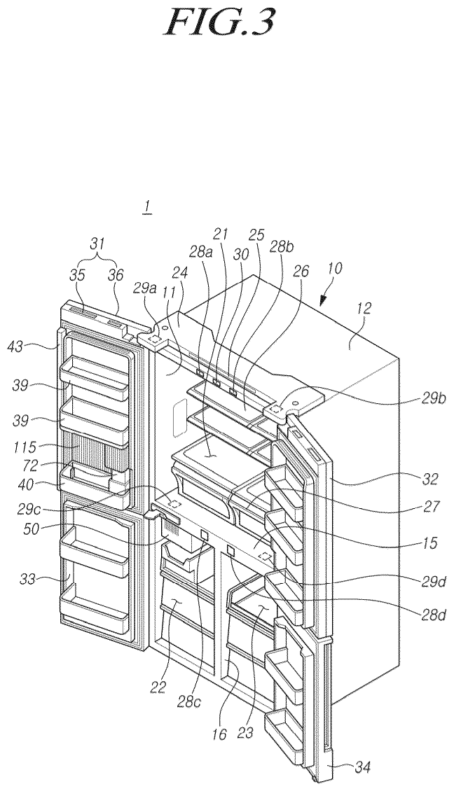

FIG. 1 is a perspective view illustrating a refrigerator with a door closed according to an embodiment of the disclosure. FIG. 2 is a perspective view illustrating a refrigerator with some doors opened, according to an embodiment of the disclosure. FIG. 3 is a perspective view illustrating a refrigerator with all doors opened according to an embodiment of the disclosure.

Referring to FIGS. 1 to 3, a refrigerator 1 may include a main body 10, storage compartments 21, 22, and 23 formed inside the main body 10, doors 31, 32, 33, and 34 opening and closing the storage compartments 21, 22, and 23, or a cold air supply device (not shown) for supplying cold air to the storage compartments 21, 22, and 23. The refrigerator 1 may include a plurality of sensors 28a, 28b, 28c, 28d, 28e, or 29a, 29b, 29c, 29d, 29e, or 70.

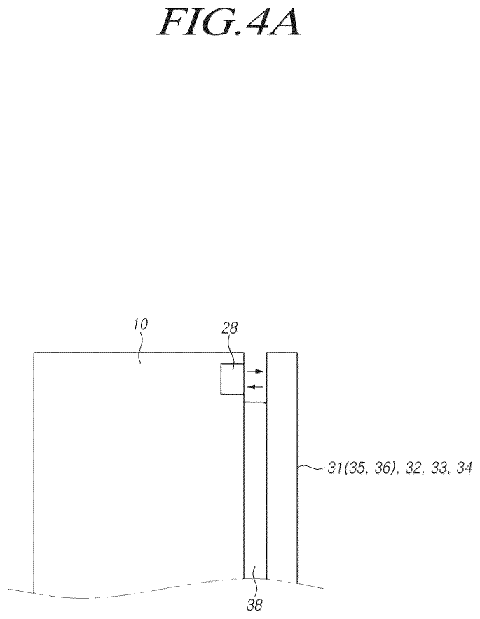

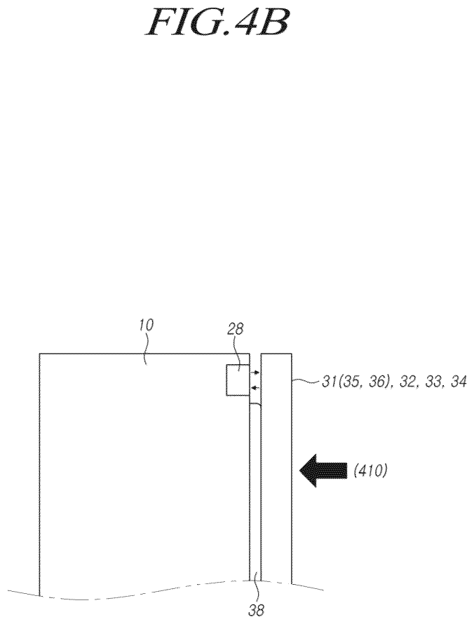

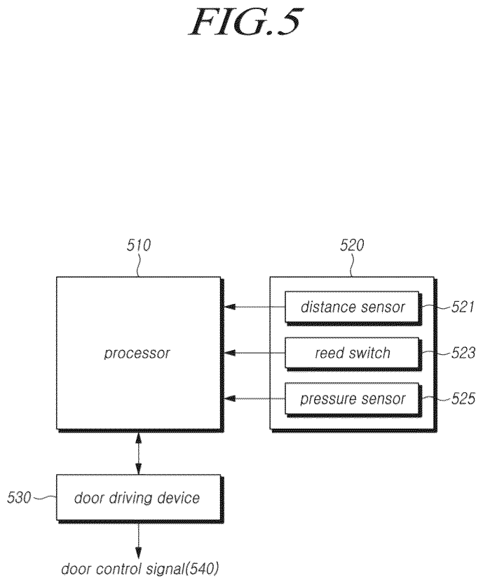

The plurality of sensors 28a, 28b, 28c, 28d, 28e or 29a, 29b, 29c, 29d, 29e or 70 may include an optical sensor (e.g., the optical sensor 521 of FIG. 5). The optical sensor may be an example of a distance sensor (hereinafter, denoted by reference numeral ‘28’). The distance sensor 28 may measure the separation distance from a target object (e.g., the door 31, 32, 33, or 34). For example, an optical sensor, one of the distance sensors 28, may generate sensing data to obtain a distance change between the main body 10 and the surface of the at least one door 31, 32, 33, or 34 that faces the main body 10 in the closed state of the door 31, 32, 33 or 34. The closed state may be a state in which the main body 10 and the door 31, 32, 33, or 34 are substantially in contact with each other (e.g., where the gasket 38 is in contact with the main body 10 as in FIGS. 1, 4A, and 4B, or where at least a portion of the gasket 38 is not in contact with the main body 10 such as in the tiny-open state described below). The sensing data may be an electrical signal according to sensing by the optical sensor. The electrical signal may have a predetermined voltage level. For example, the voltage level of the electrical signal corresponding to the sensing data may indicate a change in the distance between the main body 10 and the door 31, 32, 33, or 34 in the closed state of the door 31, 32, 33, or 34. The voltage level may increase as the distance between the main body 10 and the door 31, 32, 33, or 34 decreases. The voltage level may decrease as the distance between the main body 10 and the door 31, 32, 33, or 34 increases.

The plurality of sensors 28a, 28b, 28c, 28d, 28e or 29a, 29b, 29c, 29d, 29e or 70 may provide the obtained sensing data to another object (e.g., the processor 510 of FIG. 5). The plurality of sensors 28a, 28b, 28c, 28d, 28e or 29a, 29b, 29c, 29d, 29e or 70 may include, e.g., an optical sensor such as an IR sensor. The plurality of sensors 28a, 28b, 28c, 28d, 28e or 29a, 29b, 29c, 29d, 29e or 70 may include, e.g., an optical distance sensor such as a laser sensor. The plurality of sensors 28a, 28b, 28c, 28d, 28e or 29a, 29b, 29c, 29d, 29e or 70 may include, e.g., an ultrasonic sensor. Further, various types of sensors capable of measuring the separation distance to the target object may be used as the plurality of sensors 28a, 28b, 28c, 28d, 28e, or 29a, 29b, 29c, 29d, 29e, or 70. The plurality of sensors 28a, 28b, 28c, 28d, 28e or 29a, 29b, 29c, 29d, 29e or 70 may include a plurality of reed switches 29a, 29b, 29c, 29d, and 29e (e.g., the reed switch 523 of FIG. 5). The plurality of sensors 28a, 28b, 28c, 28d, 28e or 29a, 29b, 29c, 29d, 29e or 70 may include a pressure sensor 70 (e.g., the pressure sensor 525 of FIG. 5). In the following description, the optical sensor or other various types of sensors for obtaining a change in the distance between the main body 10 and the surface of the at least one door 31, 32, 33 or 34 that faces the main body 10 in the closed state of the door 31, 32, 33 or 34 may be referred to as ‘distance sensors 28a, 28b, 28c, 28d, and 28e’. However, the functions and/or operations of the distance sensors 28a, 28b, 28c, 28d, and 28e may be applied equally to optical sensors or other types of sensors.

The main body 10 may include an inner case 11 forming the storage compartments 21, 22, and 23. The main body 10 may include an outer case 12 coupled to the outside of the inner case 11 to form the outer appearance. The main body 10 may include an insulation material (not shown) provided between the inner case 11 and the outer case 12 to insulate the storage compartments 21, 22, and 23.

The storage compartments 21, 22, and 23 may be divided into a plurality of spaces by at least one horizontal partition wall 15 and/or at least one vertical partition wall 16. The storage compartments 21, 22, and 23 may be partitioned into the upper storage compartment 21 and the lower storage compartments 22 and 23 by at least one horizontal partition wall 15. The upper storage compartment 21 may be partitioned into an upper upper storage compartment and a lower upper storage compartment by at least one horizontal partition wall 15. The lower storage chambers 22 and 23 may be partitioned into a left lower storage chamber 22 and a right lower storage chamber 23 by at least one vertical partition wall 16. The upper storage compartment 21 may be used as a refrigerating compartment or a freezing compartment. The lower storage compartments 22 and 23 may be used as a freezing compartment or a refrigerating compartment. The division and/or use of the illustrated storage compartments 21, 22, and 23 are merely examples, but are not limited thereto. Unlike the illustration, the refrigerator 1 may be of a side-by-side (SBS) type in which the storage compartments 21, 22, and 23 are partitioned left and right by the vertical partition wall 16, a French door reflector (FDR) type in which the storage compartments 21, 22, and 23 are partitioned into an upper refrigerating compartment and a lower refrigerating compartment by the horizontal partition wall 15, and/or a one-door type with one storage compartment and one door. Shelves 26, on which food is placed, may be provided in the storage compartments 21, 22, and 23. The storage compartments 21, 22, and 23 may be provided with a storage container 27 for storing food therein.

Cold air generated by the cold air supply device may be supplied to the storage compartments 21, 22, and 23. In the storage compartments 21, 22, and 23, the upper storage compartment 21 may be opened and closed by a pair of doors 31 and 32. The doors 31 and 32 may be rotatably coupled to the main body 10. A filler 43 may be provided on at least one door 31 of the door pair 31 and 32. The filler 43 may prevent the cold air of the storage compartment 21 from leaking out between the closed doors 31 and 32.

The left lower storage compartment 22 may be opened or closed by a door 33. The door 33 may be rotatably coupled to the main body 10. The right lower storage compartment 23 may be opened or closed by a door 34. The door 34 may be rotatably coupled to the main body 10.

The doors 31, 32, 33, and 34 may include a door basket 39 having a door storage space for storing food. The doors 31, 32, 33, and 34 may be provided with a gasket 38 that is in tight contact with the front surface of the main body 10 to seal the storage compartments 21, 22, and 23 on the rear surface thereof.

At least one of the doors 31, 32, 33, and 34 may be configured as dual door having an inner door 35 and an outer door 46. For example, the left upper door 31 may include an inner door 35 and an outer door 36. The inner door 35 may be rotatably coupled to the main body 10 through a hinge. The inner door 35 may have a door inner space 56. The door inner space 56 may be formed in a central portion except for an edge portion of the inner door 35. The door inner space 56 may be formed to extend between the front surface and the rear surface of the inner door 35. When the inner door 35 is closed, the door inner space 56 may communicate with the storage compartment 21.

A door basket 39 may be mounted in the door inner space 56. A dispenser 61 may be provided in the door inner space 56. The dispenser 61 may include an operation lever 64 capable of receiving water. The user may press the operating lever 64 using a container (not shown) such as a cup. The operation lever 64 may be movably installed in a lever installation unit formed in the water supply case 100.

The dispenser 61 may include a switch that is switched on by pressurization of the operation lever 64. The dispenser 61 may include a dispenser nozzle through which water is discharged. The dispenser nozzle may be installed in the water supply case 100.

The dispenser 61 may include a water intake space 62. A container may be disposed in the water intake space 62 to receive water discharged from the dispenser nozzle. The water intake space 62 may be recessed in the front surface of the water supply case 100. For example, the dispenser nozzle may be formed to protrude to the front of the water supply case 100. In this case, the water intake space 62 may not be provided.

A water container mounting space in which the water container 72 may be mounted may be provided in the door inner space 56. An automatic water supply device 71 including a water level sensor for detecting the water level of the water container 72 mounted in the water container mounting space may be provided in the door inner space 56. The automatic water supply device 71 may include an outlet for supplying water to the water container 72 mounted in the water container mounting space.

The outer door 36 may be provided to be separated from the inner door 35 to open and close the door inner space 56. A gasket 38 may be provided on the rear surface of the outer door 36 to seal the door inner space 56. When the outer door 36 is closed, the gasket 38 may be in tight contact with the front surface of the inner door 35 near the edge of the door inner space 56. When the outer door 36 is opened, the user may access the door inner space 56.

The outer door 36 may be rotatably coupled to the inner door 35 through a hinge. The outer door 36 may rotate in the same direction as the inner door 35. The outer door 36 may have a size corresponding to the size of the inner door 35. The outer door 36 may cover the entire area of the inner door 35. The outer door 36 may be provided with a latch 37 for fixing to the inner door 35. A catch 59 may be provided in the inner door 35 to be engaged with the latch 37. When the outer door 36 is opened in a state in which the latch 37 and the catch 59 are engaged, the outer door 36 and the inner door 35 together may be opened. When the outer door 36 is opened in a state in which the latch 37 and the catch 59 are not engaged, only the outer door 36 may be opened and the inner door 35 may not be opened. A decorative panel (not shown) may be detachably coupled to the front surface of the outer door 36.

A top cover 24 may be coupled to an upper surface of the main body 10. The top cover 24 may be provided to cover a hinge and/or various electronic components disposed on the upper surface of the main body 10. A control panel 25 may be provided on a front surface of the top cover 24. The control panel 25 may display various states and/or operation information about the refrigerator 1. The control panel 25 may be used to input various commands for the operation of the refrigerator 1.

The distance sensors 28a, 28b, 28c, 28d, and 28e may be provided to face the door 31, 32, 33, or 34 from the front portion of the main body 10. For example, the distance sensors 28a, 28b, 28c, 28d, and 28e may be disposed to correspond to the doors 31, 32, 33, or 34 in a one-to-one manner. The distance sensors 28a, 28b, 28c, 28d, and 28e may sense the separation distances from the corresponding doors. The distance sensors 28a, 28b, 28c, 28d, and 28e may generate sensing data corresponding to the separation distances from the corresponding doors. The distance sensors 28a, 28b, 28c, 28d, and 28e may be provided in a portion (e.g., the horizontal partition wall 15 or the vertical partition wall 16 or an edge portion of the front portion of the main body 10) that may be substantially in tight contact with the closed door at the front portion of the main body 10.

The plurality of reed switches 29a, 29b, 29c, 29d, and 29e may be provided near the hinges for rotatably coupling the doors 31, 32, 33 or 34 to the main body 10. The plurality of reed switches 29a, 29b, 29c, 29d, and 29e may be disposed to correspond to the doors 31, 32, 33 or 34 in a one-to-one manner. The plurality of reed switches 29a, 29b, 29c, 29d, and 29e may sense the open or closed state of the corresponding door. The plurality of reed switches 29a, 29b, 29c, 29d, and 29e may generate sensing data corresponding to the open or closed state of the corresponding door.

The pressure sensor 70 may be provided in the door inner space 56 of the main body 10. The pressure sensor 70 may measure the pressure change of the door inner space 56 by a press to the door 31, 32, 33, or 34. The pressure sensor above 70 may be provided, e.g., in a cold air discharge device 60 attached to the ceiling of the door interior space above 56.

FIG. 4A is a view illustrating an example of detecting a first state in which no press occurs in a refrigerator (e.g., the refrigerator 1 of FIG. 1) in a state in which a door (e.g., the door 31, 32, 33, or 34 of FIG. 1) is closed, according to an embodiment of the disclosure. FIG. 4B is a view illustrating an example of detecting a second state in which a press occurs in a refrigerator (e.g., the refrigerator 1 of FIG. 1) in a state in which a door (e.g., the door 31, 32, 33, or 34 of FIG. 1) is closed, according to an embodiment of the disclosure.

Referring to FIG. 4A or FIG. 4B, the distance sensor 28 (e.g., the distance sensor 28a, 28b, 28c, 28d, or 28e of FIG. 2 or 3 or the optical sensor 521 of FIG. 5) to sense the separation distance between the main body 10 and the door 31, 32, 33, or 34 may be provided on the main body 10 to face the door 31, 32, 33, or 34 in the closed state of the door 31, 32, 33, or 34. Unlike the illustration, the distance sensor 28 may be provided on the door 31, 32, 33, or 34 to face the main body 10 in the closed state of the door 31, 32, 33, or 34. In the following description, the illustrated structure is described, but even if the distance sensor 28 is provided at a different position, it may be implemented in the same manner as described below.

The door 31, 32, 33, or 34 may be provided with a gasket (e.g., a gasket 38 of FIG. 2) near an outer edge of one surface (e.g., the rear surface) facing the main body 10. The gasket 38 allows the rear surface of the door 31, 32, 33, or 34 to be in tight contact with one surface (e.g., the front surface) of the main body 10. To that end, the gasket 38 may have a predetermined height. The gasket 38 allows a change (e.g., narrowing) in the separation distance between the door 31, 32, 33, or 34 and the main body 10 to occur by a press to the outer surface of the door 31, 32, 33, or 34.

The distance sensor 28 may measure the separation distance from a target object (e.g., the door 31, 32, 33, or 34). The distance sensor 28 may obtain sensing data that is an electrical signal according to the measurement result. The distance sensor 28 may provide the obtained sensing data to another object (e.g., the processor 510 of FIG. 5). The distance sensor 28 may be, e.g., an optical sensor such as an IR sensor (e.g., the optical sensor 521 of FIG. 5). The distance sensor 28 may be, e.g., an optical distance sensor such as a laser sensor. The distance sensor 28 may be, e.g., an ultrasonic sensor. Further, various types of sensors capable of measuring the separation distance to the target object may be applied to the distance sensor 28.

For example, when the optical sensor 521 such as an IR sensor is used as the distance sensor 28, the optical sensor 521 may emit an optical signal (e.g., infrared (IR) ray toward the door 31, 32, 33, or 34. The optical sensor 521 may receive the infrared ray emitted and reflected by the door 31, 32, 33, or 34. The voltage level of the infrared ray received by the optical sensor 521 may be different from the voltage level of the infrared ray emitted by the optical sensor 521. This is because the infrared ray emitted by the optical sensor above 521 is attenuated due to loss by the round trip distance to the door 31, 32, 33 or 34 and/or loss by reflection from the door 31, 32, 33 or 34. Therefore, the separation distance from the door 31, 32, 33, or 34 may be predicted based on the voltage level of infrared ray received from the optical sensor 521.

As described above, the distance sensor 28 may generate sensing data corresponding to a relatively high voltage level in a second state (e.g., see FIG. 4B) in which a press 410 occurs compared to a first state (e.g., see FIG. 4A) in which no press occurs. The first state may be, e.g., a state in which a force pressing the door 31, 32, 33, or 34 acts below a threshold level in the closed state of the door 31, 32, 33, or 34. The second state may be, e.g., a state in which a force pressing the door 31, 32, 33, or 34 exceeds the threshold level in the closed state of the door 31, 32, 33, or 34. The threshold level for determining the press may be preset. The threshold level for determining the press may be optimized through learning. The threshold level for determining the first state and/or the second state may be set according to user customization. The threshold level of user customization makes it possible, e.g., to manually control the sensitivity to detect the press to the door 31, 32, 33, or 34 in a state in which the door 31, 32, 33 or 34 is closed.

As described above, the refrigerator 1 monitors the output pattern of a sensor such as the optical sensor 521 in real time and, based thereupon, prevent malfunction from occurring, or increase the possibility that the desired operation is accurately performed. The malfunction may be, e.g., an operation according to a press due to door cleaning, leaning on the door, or sticking a memo sheet.

FIG. 5 is a block view illustrating a refrigerator (e.g., the refrigerator 1 of FIG. 1) according to an embodiment of the disclosure.

Referring to FIG. 5, the refrigerator 1 may include at least one processor 510, a plurality of sensors 520, or a door driving device 530. The plurality of sensors 520 may include one or more optical sensors 521 (e.g., the distance sensors 28a, 28b, 28c, 28d, and 28e of FIG. 2 or 3). The plurality of sensors 520 may include one or more reed switches 523 (e.g., the reed switches 29a, 29b, 29c, 29d, and 29e of FIG. 2 or 3). The plurality of sensors 520 may include a pressure sensor 525 (e.g., the pressure sensor 70 of FIG. 1).

The optical sensor 521 may be disposed to correspond to a door (e.g., the door 31, 32, 33, or 34 of FIG. 1) in a one-to-one manner or in a one-to-many manner. The optical sensor 521 may sense the separation distance from the corresponding door. The optical sensor 521 may generate sensing data corresponding to the separation distance from the corresponding door. The optical sensor 521 may be provided at a portion (e.g., the horizontal partition wall 15 or the vertical partition wall 16 of FIG. 2 or 3 or the edge portion of the front portion of the main body 10) that may be substantially in tight contact with the closed door in the front portion of the main body 10. The optical sensor 521 may provide the sensing data to the processor 510. The optical sensor 521 may perform calibration for sensing under the control of the processor 510.

The reed switch 523 may sense the operation state of the door 31, 32, 33, or 34, such as opening or closing the door 31, 32, 33, or 34 near the hinge that rotatably couples the door 31, 32, 33 or 34 to the main body 10. The reed switch 523 may generate sensing data corresponding to the open or closed state of the corresponding door. The reed switch 523 may provide the sensing data to the processor 510.

The pressure sensor 525 may be provided inside the main body 10 (e.g., the door inner space 56 of FIG. 2 or 3). The pressure sensor 70 may measure the pressure change of the door inner space 56 by a press to the door 31, 32, 33, or 34. The pressure sensor 525 may generate sensing data corresponding to a pressure change of the door internal space 56. The pressure sensor 525 may provide the sensing data to the processor 510.

The door driving device 530 may control driving for opening or closing the door 31, 32, 33, or 34 in response to a command from the processor 510. For example, when the processor 510 commands the closing of a specific door 31, 32, 33, or 34, the door driving device 530 may output a door control signal 540 for closing the specific door. For example, when the processor 510 commands the opening of a specific door 31, 32, 33, or 34, the door driving device 530 may output a door control signal 540 for opening the specific door.

According to an example, the processor 510 may predict or obtain a press pattern or a push pattern based on sensing data provided by the optical sensor 521. The processor 510 may determine a push start and/or a push end based on the sensing data. The processor 510 may collect the sensing data for a predetermined time interval and obtain a standard deviation by the collected sensing data. The standard deviation may be a value indicating the dispersion of sensing data. The dispersion map may be a value indicating how the sensing data is scattered and distributed. The processor 510 may detect a final push using the standard deviation. The processor 510 may determine a smart function corresponding to the press pattern or the push pattern, and perform the overall control for providing the determined smart function.

According to an example, the processor 510 may determine the door state based on sensing data provided by the optical sensor 521 and/or switch data provided by the reed switch 523. The door state may include, e.g., an open state, a closed state, or a tiny-open state. As an example, the processor 510 may identify whether the door 31, 32, 33, or 34 is in the open or closed state based on the switch data. If it is determined that the door 31, 32, 33, or 34 is in the closed state, the processor 510 may determine whether it is in the tiny-open state or a normal closed state based on the sensing data. For example, when the sensing data does not reach the voltage level measured in the normal closed state, the processor 510 may determine that it is in the tiny-open state. For example, when the sensing data reaches the voltage level measured in the normal closed state, the processor 510 may determine that it is in the normal closed state.

According to an example, the processor 510 may predict or obtain a press pattern or a push pattern based on sensing data provided by the pressure sensor 525. The processor 510 may determine a push start and/or a push end based on the sensing data. The processor 510 may collect the sensing data for a predetermined time interval and obtain a standard deviation by the collected sensing data. The processor 510 may determine a smart function corresponding to the press pattern or the push pattern, and perform the overall control for providing the determined smart function.

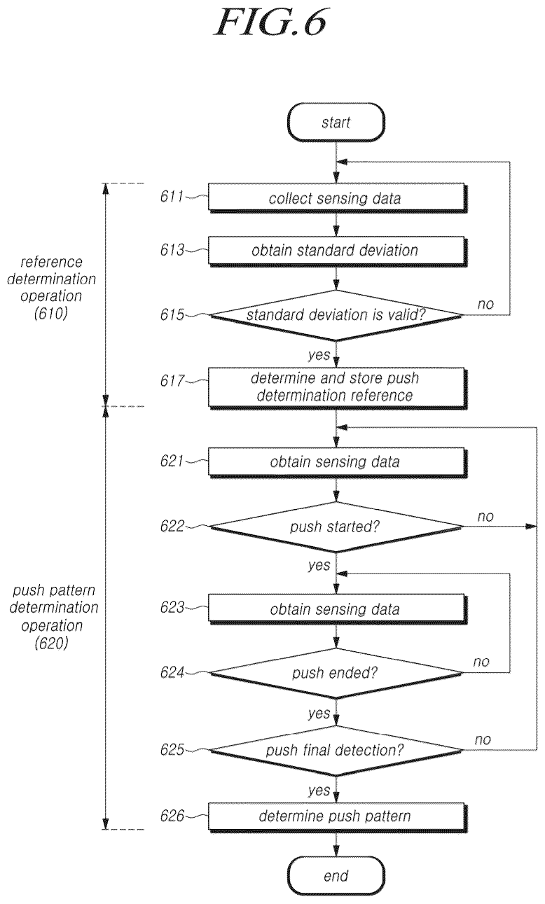

FIG. 6 is a control flowchart for determining a push pattern in a refrigerator (e.g., the refrigerator 1 of FIG. 1), according to an embodiment of the disclosure.

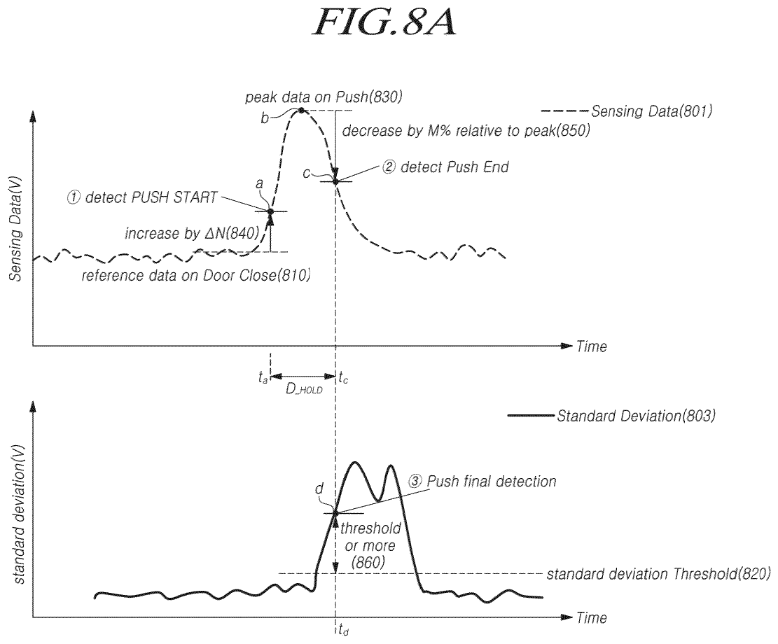

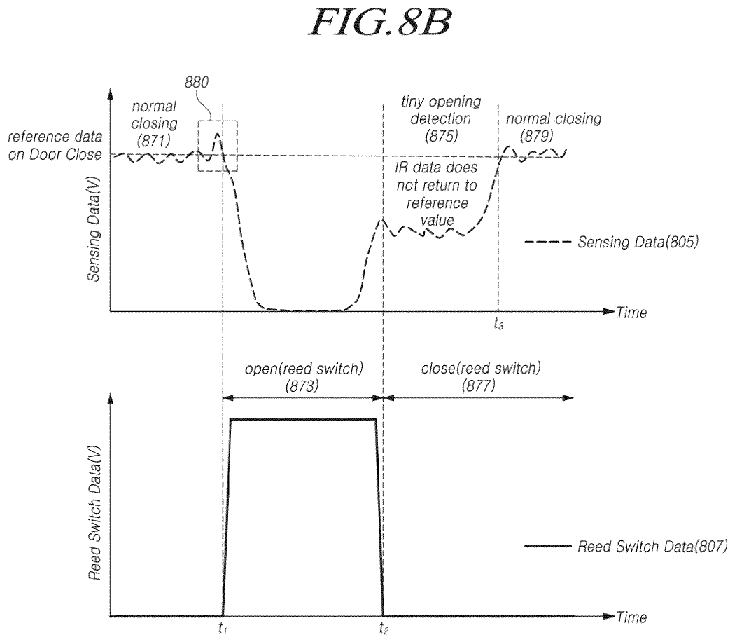

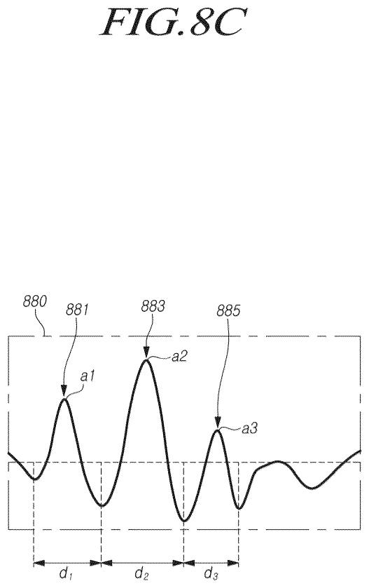

Referring to FIG. 6, in operation 610, the refrigerator 1 may perform a determination operation for determining a reference for determining a push trigger (hereinafter referred to as a “push determination reference”) (e.g., reference data 810 or standard deviation threshold 820 for determining the closed state of the door in FIG. 8A). The determination operation may include an operation of storing the determined push determination reference. For example, the push in the refrigerator 1 may be triggered by a press to the door of the refrigerator 1 (e.g., the door 31, 32, 33, or 34 in FIG. 1). The push determination reference may include a reference sensing value for determining that it is sensing data that may be obtained by a predetermined sensor (e.g., the distance sensor 28a, 28b, 28c, 28d, 28e of FIG. 2 or 3 or optical sensor 521 of FIG. 5) in response to a press to the door 31, 32, 33, or 34. When the sensing data indicates a predetermined voltage level, the reference sensing value may be a reference threshold indicating a predetermined reference voltage level. The push determination reference may be, e.g., a reference standard deviation value for determining that no further push trigger occurs due to the standard deviation obtained based on sensing data collected in a predetermined period.

More specifically, the refrigerator 1 may collect sensing data in operation 611. The sensing data may be a measurement result by the sensor (e.g., an optical sensor 521) to sense the separation distance from the position (e.g., the main body 10 of FIG. 1) of the sensor (e.g., the optical sensor 521) to the door 31, 32, 33, or 34. When the optical sensor 521 is an IR sensor, the sensing data may be data indicating the voltage level of an electrical signal into which the IR ray emitted and reflected by the door 31, 32, 33, or 34 is converted. The refrigerator 1 may collect sensing data for a predetermined time interval (e.g., 1 second). This is to obtain a standard deviation of the sensing data.

In operation 613, the refrigerator 1 may obtain a standard deviation of the collected sensing data. The standard deviation may be obtained, e.g., by taking the square of the deviation between the voltage level indicated by the sensing data and the average voltage level and taking the square root of the square value.

In operation 615, the refrigerator 1 may determine whether the obtained standard deviation is valid. For example, when the obtained standard deviation is less than or equal to the reference value STD_{threshold}, the refrigerator 1 may determine that the obtained standard deviation is valid. The reference value may be experimentally determined. The reference value may be provided to remove noise affecting the sensing data.

When it is determined that the obtained standard deviation is valid, the refrigerator 1 may determine a push determination reference in operation 617, and store the determined push determination reference. The push determination reference may include a reference sensing value for identifying a press to the door 31, 32, 33, or 34. The reference sensing value may be determined based on, e.g., an average value of voltage levels indicated by the collected sensing data.

When the reference determination operation 610 is completed, the refrigerator 1 may perform a push pattern determination operation in operation 620. The push pattern determination operation may include an operation of identifying the occurrence of a press to the door 31, 32, 33, or 34. The push pattern determination operation may include an operation of obtaining a push pattern based on the number of presses and/or press duration to the door 31, 32, 33, or 34. The push pattern determination operation may include an operation of determining a smart function to perform automatic control by the obtained push pattern and performing the determination.

More specifically, the refrigerator 1 may obtain sensing data in operation 621. The sensing data does not necessarily have to be obtained in the illustrated order. The sensing data may be continuously obtained while other operations are performed.

In operation 622, the refrigerator 10 may detect a push start PUSH START. The sensing data measured by the predetermined sensor 28 may be increased by a press to the door 31, 32, 33, or 34. For example, if there is a press to the door 31, 32, 33, or 34, the separation distance between the main body 10 and the door 31, 32, 33, or 34 will be reduced. In this case, the sensing data may increase. The increase in the sensing data corresponds to an increase in the voltage level measured by converting the infrared ray emitted and reflected from the door 31, 32, 33, or 34 into an electrical signal.

According to an example, the refrigerator 1 may determine that the push trigger has started at a time when the voltage level indicated by the sensing data rises by a predetermined value (e.g., ΔN 840 of FIG. 8A) compared to the reference voltage level in the closed state of the door 31, 32, 33, or 34 (e.g., the time ta when the voltage level of the sensing data reaches a in FIG. 8A). The reason why an increase by the predetermined level ΔN from the reference voltage level is applied is to consider that an external factor such as noise affects the sensing data. For example, the voltage level increased by the predetermined level ΔN from the reference voltage level may be defined as “reference voltage X weight α” or “reference voltage+offset voltage N”. When the voltage level of the sensing data exceeds the reference voltage level, the refrigerator 1 may determine that a push trigger has occurred.

In operation 623, the refrigerator 1 may obtain sensing data. The sensing data does not necessarily have to be obtained in the illustrated order. The sensing data may be continuously obtained while other operations are performed.

In operation 624, the refrigerator 10 may detect a push end PUSH END. The sensing data measured by the predetermined sensor 28 may decrease when the external force that causes the press to the door 31, 32, 33, or 34 is reduced. For example, if there is a press to the door 31, 32, 33, or 34, but the strength of the press decreases, the separation distance between the main body 10 and the door 31, 32, 33 or 34 will increase. In this case, the sensing data may be reduced. The decrease in the sensing data corresponds to a decrease in the voltage level measured by converting the infrared ray emitted and reflected from the door 31, 32, 33, or 34 into an electrical signal. The refrigerator 1 may detect the push end PUSH END based on the degree of the decreasing voltage level.

According to an example, the refrigerator 1 may determine that the press is terminated PUSH END at the time when the sensing data decreases by a predetermined ratio M % to the maximum sensing data. Determining the press end PUSH END by a decrease by the predetermined ratio M % in the maximum sensing data is done so to consider that an external factor such as noise affects the sensing data.

If detecting the press end PUSH END, the refrigerator 1 may determine whether the final press has occurred in operation 625. The occurrence of the final press is for determining that no further press is to occur later or for determining the time not to be considered to determine the push pattern although a press occurs. For example, the refrigerator 1 may continuously monitor a change in the standard deviation based on the sensing data. If the press to the door 31, 32, 33, or 34 is continuously maintained, the standard deviation may be changed. The change in the standard deviation may be caused by an increase or decrease in the external force generating the press. The refrigerator 1 may monitor whether the standard deviation starts to increase and reaches the standard deviation threshold. When the standard deviation exceeds the standard deviation threshold and increases by a threshold offset, the refrigerator 1 may consider that a final press for determining that no further press occurs has occurred.

In operation 626, the refrigerator 1 may determine a push pattern. The push pattern may be predicted by the number of presses and/or press duration based on a change in sensing data. For example, the refrigerator 1 may count the number of presses to the door 31, 32, 33, or 34 by detecting a press start PUSH STRART, a press end PUSH END, and/or a final press based on a pattern in which sensing data changes. For example, the sensing data change pattern may detect that one press has occurred due to one press start PUSH STRART and one press end PUSH END. The refrigerator 1 may detect that repeated presses have occurred due to a plurality of press starts PUSH STRART and a plurality of press ends PUSH END (c). The refrigerator 1 may set a smart function for each number of presses. In this case, the refrigerator 1 may identify a smart function set corresponding to the number of presses and process the identified smart function. The smart function may be a function that may be provided by the refrigerator 1, such as a welcome light function or a door open function.

The refrigerator 1 may obtain press duration by a press start time PUSH STRART and a press end time PUSH END based on a pattern in which sensing data changes. The refrigerator 1 may obtain press duration by a press start time PUSH STRART and a press final detection time based on a pattern in which sensing data changes. The refrigerator 1 may determine a situation such as press malfunction or simple control deactivation considering the press duration.

The refrigerator 1 may predict the press pattern based on the number of presses and/or press duration to the door 31, 32, 33, or 34. The refrigerator 1 may set the smart function corresponding to each of the plurality of press patterns. In this case, the refrigerator 1 may identify a smart function set corresponding to the predicted press pattern and process the identified smart function. The smart function may be a function that may be provided by the refrigerator 1, such as a welcome light function or a door open function. The refrigerator 1 may repeatedly perform the above-described operations and perform learning based on the result to optimize prediction of a press pattern.

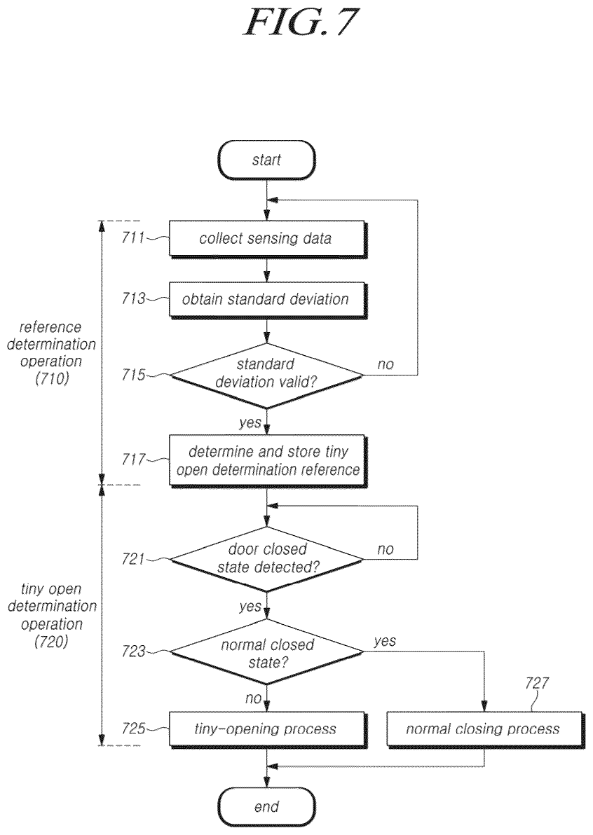

FIG. 7 is a control flowchart for determining tiny opening in a refrigerator (e.g., the refrigerator 1 of FIG. 1) according to an embodiment of the disclosure.

Referring to FIG. 7, in operation 710, the refrigerator 1 may perform an operation of determining a reference for determining a fine opening (hereinafter referred to as a “fine opening determination reference”) (e.g., reference data for determining the fine opening state of the door in FIG. 8B). The determination operation may include an operation of storing the determined tiny-open determination reference. For example, the tiny opening in the refrigerator 1 may occur in the operation in which the door (e.g., the door 31, 32, 33, or 34 of FIG. 1) of the refrigerator 1 is closed. The tiny-open determination reference may include a reference sensing value for determining whether sensing data that may be obtained by a predetermined sensor (e.g., the distance sensor 28a, 28b, 28c, 28d, 28e of FIG. 2 or the optical sensor 521 of FIG. 5) in response to the closing of the open door 31, 32, 33, or 34 is measured in the tiny-open state.

More specifically, the refrigerator 1 may collect sensing data in operation 711. The sensing data may be a measurement result by the sensor (e.g., an optical sensor 521) to sense the separation distance from the position (e.g., the main body 10 of FIG. 1) of the sensor (e.g., the optical sensor 521) to the door 31, 32, 33, or 34. When the optical sensor 521 is an IR sensor, the sensing data may be data indicating the voltage level of an electrical signal into which the IR ray emitted and reflected by the door 31, 32, 33, or 34 is converted. The refrigerator 1 may collect sensing data for a predetermined time interval (e.g., 1 second). This is to obtain a standard deviation of the sensing data.

In operation 713, the refrigerator 1 may obtain a standard deviation of the collected sensing data. The standard deviation may be obtained, e.g., by taking the square of the deviation between the voltage level indicated by the sensing data and the average voltage level and taking the square root of the square value.

In operation 715, the refrigerator 1 may determine whether the obtained standard deviation is valid. For example, when the obtained standard deviation is less than or equal to the reference value STD_{threshold}, the refrigerator 1 may determine that the obtained standard deviation is valid. The reference value may be experimentally determined. The reference value may be provided to remove noise affecting the sensing data.

When it is determined that the obtained standard deviation is valid, the refrigerator 1 may determine a tiny-open determination reference in operation 717, and store the determined tiny-open determination reference. The tiny-open determination reference may include a reference sensing value for identifying the tiny opening of the door 31, 32, 33, or 34. The reference sensing value may be determined based on, e.g., an average value by voltage levels of sensing data collected in a state in which the door 31, 32, 33, or 34 is tiny-opened.

When the reference determination operation 710 is completed, the refrigerator 1 may perform a tiny-open determination operation in operation 720. The tiny-open determination operation may include an operation of identifying that the door 31, 32, 33, or 34 is not completely closed in the process of closing the door 31, 32, 33, or 34, but there is a tiny gap between the main body 10 and the door 31, 32, 33, or 34. The tiny-open determination operation should be preceded by determination on the opening or closing of the door 31, 32, 33, or 34 based on switch data of a predetermined switch (e.g., the reed switch 29a, 29b, 29c, 29d, 29e of FIG. 2 or 3) or the reed switch 523 of FIG. 5 (hereinafter denoted by reference numeral “29”). If the refrigerator 1 recognizes the closing of the door 31, 32, 33, or 34 by the switch data, it may identify whether the door is tiny-opened based on the sensing data measured by the predetermined sensor 28.

More specifically, in operation 721, the refrigerator 1 may detect the closed state of the door 31, 32, 33, or 34 based on the change in switching data generated by the predetermined switch 29. For example, the refrigerator 1 may determine that the open door 31, 32, 33, or 34 is closed when the voltage level of the switching data is changed from a high state to a low state. Depending on the type or installation method of the predetermined switch 29, the voltage level of the switching data according to the opening or closing of the door 31, 32, 33, or 34 may be opposite.

The closed state determined based on the switching data of the predetermined switch 29 may not be the normal closed state. In other words, the closed state determined by the switching data may be one of the tiny-open state and the normal closed state. The tiny-open state may visually appear that the door 31, 32, 33, or 34 is closed, but the door 31, 32, 33, or 34 may be spaced apart from the main body (e.g., such as where at least a portion of the gasket 38 is not in contact with the main body 10, or is not fully compressed). The refrigerator 1 may refer to sensing data measured by the predetermined sensor 28 to determine the tiny-open state or the normal closed state.

According to an example, when the refrigerator 1 detects the closing of the door 31, 32, 33, or 34, in operation 723, the refrigerator 1 may determine whether the door 31, 32, 33, or 34 is in the normal closed state. This may be determined based on sensing data measured by the predetermined sensor 28. If the door 31, 32, 33, or 34 is closed, the voltage level of sensing data output by the predetermined sensor 28 may also increase rapidly as the separation distance between the doors 31, 32, 33 or 34 and the main body 10 decreases rapidly. However, the voltage level of the sensing data 805 may not increase to the voltage level in the normal closed state. This may occur in a state in which the door 31, 32, 33, or 34 is not completely closed but is tiny-opened. It may be why in the tiny opening, the separation distance between the main body 10 and the door 31, 32, 33, or 34 may be slightly larger than the separation distance in the normal closed state. In this case, the voltage level of the sensing data output by the predetermined sensor 28 may not return to the voltage level corresponding to the reference data until the door 31, 32, 33, or 34 is normally closed. The reference data may correspond to the tiny-open determination reference determined in the reference determination operation 710.

As described above, when switch data indicating the closed state is output by the predetermined switch 29, but sensing data having a voltage level of a reference data level is not output by the predetermined sensor 28, the refrigerator 1 may determine that tiny opening has occurred.

If it is determined that the door 31, 32, 33, or 34 is not normally closed but are in a state in which tiny-opening has occurred, the refrigerator 1 may process the corresponding function according to the occurrence of tiny-opening in operation 725. The refrigerator 1 may output visual data for indicating tiny-opening through a display, for example. The refrigerator 1 may output an auditory warning sound for indicating tiny-opening through a speaker, for example. The refrigerator 1 may forcibly close the door 31, 32, 33, or 34 by controlling a door driving device (e.g., the door driving device 530 of FIG. 5).

When it is determined that the door 31, 32, 33, or 34 is in the normal closed state, the refrigerator 1 may process the corresponding function according to the normal closing in operation 727. The refrigerator 1 may output visual data indicating that the door 31, 32, 33, or 34 is normally closed through a display, for example. The refrigerator 1 may output an auditory guide sound for indicating the normal closed state through, e.g., a speaker.

FIG. 8A is an example of a waveform view for identifying a press or press pattern to a door (e.g., the door 31, 32, 33, or 34 of FIG. 1) in a refrigerator (e.g., the refrigerator 1 of FIG. 1) according to an embodiment of the disclosure. FIG. 8B is an example of a waveform diagram for identifying an open state of a door (e.g., the door 31, 32, 33, or 34 of FIG. 1) in a refrigerator (e.g., the refrigerator 1 of FIG. 1) according to an embodiment of the disclosure. FIG. 8C is an example of a press pattern to a door (e.g., the door 31, 32, 33, or 34 of FIG. 1) in a refrigerator (e.g., the refrigerator 1 of FIG. 1) according to an embodiment of the disclosure.

Referring to FIG. 8A, changes over time in sensing data 801 (e.g., the voltage level of received infrared light) measured by a predetermined sensor (e.g., the distance sensor 28a, 28b, 28c, 28d, 28e of FIG. 2 or 3 or the optical sensor 521 of FIG. 5) (hereinafter denoted by reference numeral “28”) are indicated by dashed lines. The predetermined sensor 28 may measure the separation distance between the main body (e.g., the main body 10 of FIG. 1) and the door 31, 32, 33, or 34. The sensor 28 measuring the distance is as defined above. For example, the predetermined sensor 28 may be an IR sensor. Hereinafter, for convenience of description, it is assumed that the predetermined sensor 28 is an IR sensor.

A standard deviation for the sensing data 801 that changes over time, indicated by dashed line is calculated, and the calculated changes in the standard deviation are indicated by solid line 803. The standard deviation 803 makes it possible to predict a deviation of the voltage level measured to predict the distance from the reference voltage level.

If no press to the door 31, 32, 33, or 34 of the refrigerator 1 occurs in the normal closed state of the door 31, 32, 33, or 34 of the refrigerator 1, the sensing data 801 may be measured in substantially the same manner as the reference data 810. The reference data 810 may be obtained by an experiment. The experiment may be, e.g., measuring the sensing data 801 in a state in which the door 31, 32, 33, or 34 of the refrigerator 1 is not normally closed, and there is no press to the door 31, 32, 33, or 34. The reference data 810 may be determined for convergence of the sensing data 801 obtained by performing the experiment repeatedly or for the average of the sensing data 801. The reference data 810 may be updated through repeated learning after being actually applied to the product. The reference data 810 may be initialized by a request. The reference data 810 may be adjusted to a predetermined value by a request.

When there is a press to the door 31, 32, 33, or 34, the sensing data 801 measured by the predetermined sensor 28 may increase. For example, if there is a press to the door 31, 32, 33, or 34, the separation distance between the main body 10 and the door 31, 32, 33, or 34 will be reduced. In this case, the sensing data 801 may increase. The increase in the sensing data 801 corresponds to an increase in the voltage level measured by converting the infrared ray received by reflecting the emitted infrared ray from the door 31, 32, 33, or 34 into an electrical signal. The refrigerator 1 may detect that a press is started (PUSH START) at the time tₐ when the sensing data 801 reaches a first target value a increased by a predetermined level ΔN from the reference data 810 (\textcircled{1}). The reason why an increase 840 by the predetermined level ΔN from the reference data 810 is applied is to consider that an external factor such as noise affects the sensing data 801.

The refrigerator 1 may continuously monitor changes in the sensing data 801 even after detecting the start of the press. If the press to the door 31, 32, 33, or 34 is continuously maintained, the sensing data 801 may continuously increase. This may occur in a time interval from when the press is started until the maximum external force is applied. The refrigerator 1 may set or update the maximum sensing data (Peak Sensing Data) 830 according to the increase in the sensing data 801. The maximum sensing data 830 may be finally obtained after the sensing data 801 decreases.

The refrigerator 1 may recognize that the sensing data 801 decreases at the time (point b) when the maximum sensing data 830 is measured. The refrigerator 1 may detect that the press is stopped (PUSH END) at the time t_{c} when the sensing data 801 reaches a second target value c decreased by a predetermined ratio M % to the maximum sensing data 830 (\textcircled{2}). The reason why a decrease 850 by the predetermined ration M % from the maximum sensing data 830 is applied is to consider that an external factor such as noise affects the sensing data 801.

The refrigerator 1 may continuously monitor a change in the standard deviation based on the sensing data 801. If the press to the door 31, 32, 33, or 34 is continuously maintained, the standard deviation 803 may be changed. The change in the standard deviation 803 may be caused by an increase or decrease in the external force generating the press. The refrigerator 1 may monitor whether the standard deviation 803 starts to increase and reaches the standard deviation threshold 820. When the standard deviation 803 exceeds the standard deviation threshold 820 and then reaches a point d where it is increased by a threshold offset 860, the refrigerator 1 may detect (\textcircled{3}) the final press for determining that no further press occurs.

At the press final detection point (point d), the refrigerator 1 may determine that no press occurs or, although a press occurs, the press does not affect the change pattern of the sensing data. The press final detection (point d) may be performed at the same time (t_{c} or t_{d}) as the press end (PUSH END) (point c). The reason why the standard deviation threshold 820 and/or the threshold offset 860 is applied is to consider that an external factor such as noise affects the sensing data 801.

The refrigerator 1 may count the number of presses to the door 31, 32, 33, or 34 by detecting a press start PUSH STRART (\textcircled{1}), a press end PUSH END (\textcircled{2}), and/or a final press (\textcircled{3}) based on a pattern in which sensing data changes. The drawings illustrate an example of a sensing data change pattern in which one press start PUSH START (a) and one press end PUSH END (c) are detected by one press, but multiple press starts PUSH START and multiple press ends PUSH ENDS (c) may be detected by repeated presses. The refrigerator 1 may set a smart function for each number of presses. In this case, the refrigerator 1 may identify a smart function set corresponding to the number of presses and process the identified smart function. The smart function may be a function that may be provided by the refrigerator 1, such as a welcome light function or a door open function.

The refrigerator 1 may obtain press duration D__{HOLD} by the press start PUSH START time tₐ and the press end PUSH END time t_{c} based on the pattern in which the sensing data 801 is changed. The refrigerator 1 may obtain the press duration D__{HOLD} by the press start PUSH START time tₐ and the press final detection time t_{d} based on the pattern in which the sensing data 801 is changed. The drawings illustrate an example of the sensing data change pattern in which the press duration D__{HOLD} is obtained by one press start PUSH START time tₐ and one press end PUSH END t_{c} the or press final detection time tₐ according to one press, but the press duration D__{HOLD} may be changed by repeated presses. The refrigerator 1 may determine a situation such as press malfunction or simple control deactivation considering the press duration D HOLD.

The refrigerator 1 may predict the press pattern based on the number of presses and/or press duration D__{HOLD} to the door 31, 32, 33, or 34. The refrigerator 1 may set the smart function corresponding to each of the plurality of press patterns. In this case, the refrigerator 1 may identify a smart function set corresponding to the predicted press pattern and process the identified smart function. The smart function may be a function that may be provided by the refrigerator 1, such as a welcome light function or a door open function. The refrigerator 1 may repeatedly perform the above-described operations and perform learning based on the result to optimize prediction of a press pattern.

Referring to FIG. 8B, changes over time in switch data 807 measured by a switch (e.g., the reed switch 29a, 29b, 29c, 29d, or 29e of FIG. 2 or 3 or the reed switch 523 of FIG. 5) (hereinafter denoted by reference numeral “29”) are indicated by solid line. The above-described switch 29 may generate switch data 807 that identifies whether the door 31, 32, 33 or 34 is closed or opened. As an example, the predetermined side wall may be closed by the closing of the door 31, 32, 33, or 34 and be opened by the opening of the door 31, 32, 33, or 34. The predetermined switch 29 may be operated in the opposite way. The predetermined switch 29 may generate low-level switch data 807, e.g., in response to the closing of the door 31, 32, 33, or 34. The predetermined switch 29 may generate high-level switch data 807, e.g., in response to the opening of the door 31, 32, 33, or 34. As shown, it may be identified that the door 31, 32, 33, or 34 is opened at the time t₁, and the door 31, 32, 33, or 34 is closed at the time t₂. In this case, the predetermined switch 29 outputs the switch data 807 corresponding to the closed state 871 until the time t₁ when the door 31, 32, 33, or 34 is opened, outputs the switch data 807 corresponding to the open state 873 from the time t₁ when the door 31, 32, 33, or 34 is opened to the time t₂ when the door 31, 32, 33, or 34 is closed, and outputs the switch data 807 corresponding to the closed state 877 from the time t₂ when the door 31, 32, 33, or 34 is closed. After the time t₂ determined by the predetermined switch 29, the closed state 877 may not be the normal closed state. In other words, the closed state 877 determined by the predetermined switch 29 may be one of the tiny-open state or the normal closed state. The tiny-open state may visually appear that the door 31, 32, 33, or 34 is closed, but the door 31, 32, 33, or 34 may be spaced apart from the main body (e.g., such as where at least a portion of the gasket 38 is not in contact with the main body 10, or is not fully compressed). The refrigerator 1 may refer to the sensing data 805 (e.g., the voltage level of the received IR ray) measured by a predetermined sensor (e.g., the distance sensor 28a, 28b, 28c, 28d, 28e of FIG. 2 or 3 or the optical sensor 521 of FIG. 5) (hereinafter denoted by reference numeral “28”) to determine the tiny-open state or the normal closed state.

Changes over in the sensing data 805 measured by the predetermined sensor 28 are denoted by dashed line. The predetermined sensor 28 may measure the separation distance between the main body 10 and the door 31, 32, 33, or 34. The sensor 28 measuring the distance is as defined above. For example, the predetermined sensor 28 may be an IR sensor. Hereinafter, for convenience of description, it is assumed that the predetermined sensor 28 is an IR sensor.

When a press to the door 31, 32, 33, or 34 occurs in the normal closed state 871 of the door 31, 32, 33, or 34, the sensing data 805 output by the predetermined sensor 28 may be temporarily changed (see 880). Changes in the sensing data 805 in reference number 880 may be identified by the enlarged graph of FIG. 8A. The description has been described above, and thus, no further description is given.

If the door 31, 32, 33, or 34 is opened, the voltage level of sensing data output by the predetermined sensor 28 may also decrease rapidly as the separation distance between the doors 31, 32, 33 or 34 and the main body 10 increases rapidly. In the drawings, it is identified that at the time t₁ when the door 31, 32, 33, or 34 is predicted to be opened, the voltage level of the sensing data 805 is sharply decreased. At the time t₁, the opening of the door 31, 32, 33, or 34 may be identified by the switch data 807 obtained by the predetermined switch 29.

If the door 31, 32, 33, or 34 is closed, the voltage level of sensing data output by the predetermined sensor 28 may also increase rapidly as the separation distance between the doors 31, 32, 33 or 34 and the main body 10 decreases rapidly. In the drawings, it is identified that at the time t₂ when the door 31, 32, 33, or 34 is predicted to be closed, the voltage level of the sensing data 805 is sharply increased. At the time t₂, the closing of the door 31, 32, 33, or 34 may be identified by the switch data 807 obtained by the predetermined switch 29. However, the voltage level of the sensing data 805 at the time t₂ may not increase to the voltage level in the normal closed state 871 or 879. This may occur in a state in which the door 31, 32, 33, or 34 is not completely closed but is tiny-opened. It may be why in the tiny opening, the separation distance between the main body 10 and the door 31, 32, 33, or 34 may be slightly larger than the separation distance in the normal closed state 871 or 879. In this case, the voltage level of the sensing data 805 output by the predetermined sensor 28 may not return to the voltage level corresponding to the reference data until the time t₃ when the door 31, 32, 33, or 34 is normally closed (879).

As described above, when switch data 807 indicating the closed state is output by the predetermined switch 29, but sensing data 805 having a voltage level of a reference data level is not output by the predetermined sensor 28, the refrigerator 1 may determine that tiny opening has occurred (875).

If the tiny opening is released (time t₃), the voltage level of the sensing data 805 output by the predetermined sensor 28 will increase to the voltage level of the reference data. In this case, the refrigerator 1 may determine that the door 31, 32, 33, or 34 is in the normal closed state.

Referring to FIG. 8C, the refrigerator 1 may determine a press pattern 880 for predicting a distance change between the main body 10 and the surface of the at least one door 31, 32, 33, or 34 that faces the main body 10 in a closed state in which the main body 10 and at least one door 31, 32, 33, or 34 are substantially in contact with each other by the sensing data 801. The press pattern 880 may indicate, e.g., that the outer surface of the door 31, 32, 33, or 34 has been consecutively pressed a predetermined number of times (e.g., three times) (881, 883, and 885). In the press pattern 880, one press 881, 883, or 885 may have one maximum value or one peak value a1, a2, or a3 and one minimum value. A start time and an end time corresponding to the one press 881, 883, or 885 may determine press duration d₁, d₂, or d₃ during which the pressed state of the outer surface is maintained in the door 31, 32, 33, or 34.

The number of presses of the door 31, 32, 33, or 34 may be counted. The sensing data change pattern 880 shown in the drawings shows an example in which three press starts PUSH START and three press ends PUSH END are detected in response to three presses, but more press starts PUSH START and more press ends PUSH END may be detected by repeated presses. The refrigerator 1 may set a smart function for each number of presses. In this case, the refrigerator 1 may identify a set smart function corresponding to the number of presses and process the identified smart function. The smart function may be a function that may be provided by the refrigerator 1, such as a welcome light function or a door open function.

The refrigerator 1 may obtain press duration or a press retention time d₁, d₂, or d₃ by the press start PUSH START time and the press end time PUSH END based on the press pattern 880. The press pattern 880 representing a change in sensing data shown in the drawings shows an example of obtaining the press duration or press retention time d₁, d₂, or d₃ by the three press start PUSH START times, three press end PUSH END times or press final detection times according to the three presses 881, 883, and 885, but the press duration d₁, d₂, or d₃ may be changed by repeated presses. The refrigerator 1 may determine a situation such as press malfunction or simple control deactivation considering the press duration d₁, d₂, or d₃.

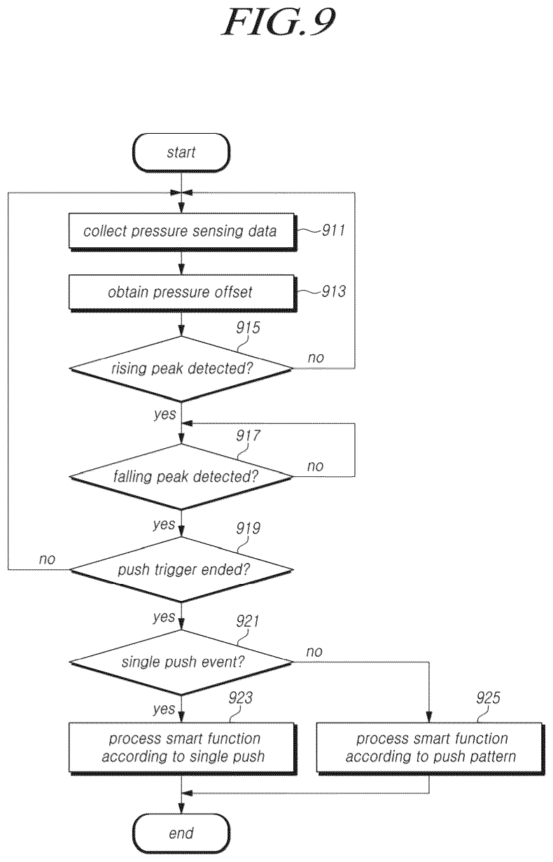

FIG. 9 is a control flowchart for determining a push pattern in a refrigerator (e.g., the refrigerator 1 of FIG. 1), according to an embodiment of the disclosure.

Referring to FIG. 9, in operation 911, the refrigerator 1 may collect pressure sensing data P. The pressure sensing data may be measured by a predetermined sensor (e.g., the pressure sensor 70 of FIG. 1 or the pressure sensor 525 of FIG. 5) (hereinafter, denoted by reference number “70”) provided in the door inner space (e.g., the door inner space of the main body (e.g., the main body 10 of FIG. 1) (e.g., the door inner space 56 of FIG. 2) (hereinafter denoted by reference numeral “70”). The pressure sensing data P may be data indicating a voltage level of the electrical signal into which the pressure data measured in the door inner space 56 has been converted. The refrigerator 1 may collect sensing data for a predetermined time interval (e.g., 5 seconds).

The refrigerator 1 may obtain a rising pressure offset ΔP+ and/or a falling pressure offset ΔP− by the pressure sensing data. The rising pressure offset ΔP+ may be obtained by a difference value between a reference pressure value substantially converging when no press occurs and a measured pressure value corresponding to pressure sensing data in the period in which the pressure increases. The falling pressure offset ΔP− may be obtained by a difference value between a reference pressure value substantially converging when no press occurs and a measured pressure value corresponding to pressure sensing data in the period in which the pressure decreases.

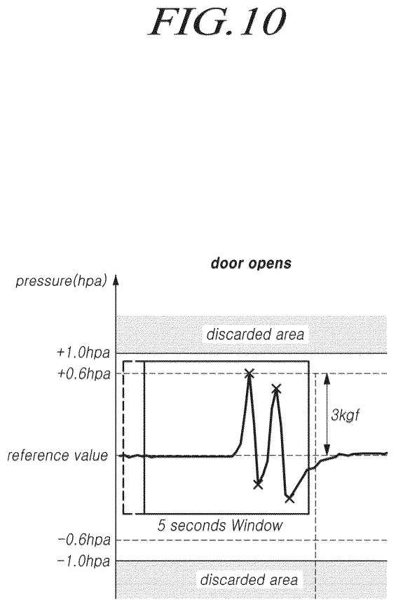

In operation 915, the refrigerator 1 may determine whether the pressure sensing data has reached a rising peak. For example, the refrigerator 1 may determine that the rising peak has been reached when the rising pressure offset ΔP+ exceeds a first threshold a1 for determining the rising peak. The rising peak corresponds to, e.g., ‘x’ indicated above the reference value in FIG. 10.

In operation 917, the refrigerator 1 may determine whether the pressure sensing data has reached a falling peak. For example, when the falling pressure offset ΔP− falls below a second threshold a2 for determining the falling peak, the refrigerator 1 may determine that the falling peak has been reached. The falling peak corresponds to, e.g., ‘x’ indicated below the reference value in FIG. 10.

In operation 919, the refrigerator 1 may determine whether the push trigger has ended. For example, when a set time (e.g., 5 seconds) elapses, the refrigerator 1 may determine that the push trigger has ended.

If the push trigger ends, the refrigerator 1 may determine whether it is a single push event in operation 921. For example, when one rising peak and one falling peak are detected, the refrigerator 1 may determine that a single push event has occurred. For example, when a plurality of rising peaks and a plurality of falling peaks are detected, the refrigerator 1 may determine that a multi-push event has occurred.

When it is determined that a single push event has occurred, the refrigerator 1 may process a smart function according to the single push in operation 923. When it is determined that a multi-push event has occurred, the refrigerator 1 may process a smart function according to the push pattern in operation 925.

FIG. 10 is an example of an internal pressure change pattern for identifying a press or press pattern to a door (e.g., the door 31, 32, 33, or 34 of FIG. 1) in a refrigerator (e.g., the refrigerator 1 of FIG. 1) according to an embodiment of the disclosure.

Referring to FIG. 10, sensing data measured by a predetermined sensor (e.g., the pressure sensor 70 of FIG. 1 or the pressure sensor 525 of FIG. 5) (hereinafter denoted by reference numeral “70”) may be changed by a press to the door 31, 32, 33, or 34. The predetermined sensor 70 may be provided in a door inner space (e.g., the door inner space 56 of FIG. 2) of the main body (e.g., the main body 10 of FIG. 1). The predetermined sensor 70 may measure the pressure change in the door inner space 56 by a press to the door 31, 32, 33, or 34. The predetermined sensor 70 may be provided, e.g., in a cold air discharge device attached to the ceiling of the door inner space 56.

According to an example, the sensing data may substantially converge to a reference value when no press occurs. The pressure of the door inner space 56 may gradually increase until the external force generating the press reaches the maximum value and reach the upper limit. The pressure of the door inner space 56 may gradually decrease until the external force generating the press decreases from the maximum value and completely disappears and reach the lower limit.

The refrigerator 1 may determine that one press occurs by one cycle in which the pressure of the door inner space 56 reaches the upper limit and then reaches the lower limit. The refrigerator 1 may obtain the number of presses based on a pressure change in the door inner space 56 for a predetermined measurement period (e.g., 5 seconds). As shown, it may be identified that two presses have occurred. The refrigerator 1 may set an effective pressure range (e.g., +1.0 hpa to −1.0 hpa), and may regard the sensing data outside the set effective pressure range as an error due to noise and discard it.

For example, the refrigerator 1 may include a main body 10. The refrigerator 10 may include at least one door 31, 32, 33, or 34 rotatably coupled to the main body 10. The refrigerator 10 may include at least one sensor 520. The refrigerator 10 may include a processing circuit, and may include at least one processor 510 configured to identify the state of the door 31, 32, 33, or 34 considering sensing data provided by the at least one sensor 520. The at least one processor 510 may be configured to obtain a distance change between the main body 10 and a surface of the at least one door 31, 32, 33, or 34 that faces the main body 10 in a closed state in which the main body 10 and the at least one door 31, 32, 33, or 34 substantially contact each other by the sensing data. The at least one processor 510 may be configured to determine first press patterns of the door 31, 32, 33, or 34 based on the obtained distance change. The at least one processor 510 may be configured to perform control for providing a first smart function corresponding to the determined first press pattern. The first press pattern may be determined by at least one of a first press count or first press duration in response to a press to an outer surface of the door 31, 32, 33, or 34.

As an example, the at least one processor 510 may be configured to obtain a first number of times in which a sensing voltage level indicating the distance change reaches a predetermined first threshold for determining a press start.

As an example, the at least one processor 510 may be configured to obtain a second number of times in which the sensing voltage level reaches a predetermined second threshold for determining a press release.

As an example, the at least one processor 510 may be configured to obtain a press end as the sensing voltage level reaches a predetermined third threshold for determining a final press release.

As an example, the at least one processor 510 may be configured to identify the first press count based on the obtained first number of times and the obtained second number of times in response to the obtained press end.

As an example, the at least one processor 510 may be configured to identify the first press duration by a time interval between a first time of reaching the predetermined first threshold and a second time of reaching the second threshold in response to the obtained press end.

The at least one sensor 520 may include a reed switch 523.

As an example, the at least one processor 510 may be configured to determine an open state or a closed state of the door 31, 32, 33, or 34 based on an output signal of the reed switch 523.

As an example, the at least one sensor 520 may include an optical sensor 521.

As an example, the at least one processor 510 may be configured to collect sensing data corresponding to a distance between the main body 10 and the surface of the door 31, 32, 33, or 34 that faces the main body 10 through the optical sensor 521.

As an example, the at least one processor 510 may be configured to obtain a standard deviation using the collected sensing data.

As an example, the at least one processor 510 may be configured to set the predetermined first threshold and the predetermined second threshold considering the standard deviation.

As an example, the at least one sensor 520 may include a pressure sensor 525.

As an example, the at least one processor 510 may be configured to obtain a pressure change inside the main body 10 based on sensing data provided by the pressure sensor 525.

As an example, the at least one processor 510 may be configured to determine a second press pattern based on the obtained pressure change.

As an example, the at least one processor 510 may be configured to identify a second smart function corresponding to the determined second press pattern.

As an example, the at least one processor 510 may be configured to perform control for providing the identified second smart function.

As an example, the second press pattern may be determined by at least one of a second press count or second press duration in response to a press to an outer surface of the door 31, 32, 33, or 34.

As an example, the at least one processor 510 may be configured to identify a press start on the outer surface based on the sensing data.

As an example, the at least one processor 510 may be configured to identify a press end on the outer surface based on the sensing data.

As an example, the at least one processor 510 may be configured to detect a final press by a standard deviation of the sensing data.

As an example, the at least one processor 510 may be configured to obtain the first press count considering the press start, the press end, and the final press.

As an example, the at least one processor 510 may be configured to identify a press start on the outer surface based on the sensing data.

As an example, the at least one processor 510 may be configured to identify a press end on the outer surface based on the sensing data.

As an example, the at least one processor 510 may be configured to obtain the first press duration by a time interval between a time of identifying the press start and a time of identifying the press end.

As an example, the at least one sensor 520 may include an optical sensor 521 and a reed switch 523.

As an example, the at least one processor 510 may be configured to identify a closed state of the door 31, 32, 33, or 34 by the reed switch 523.

As an example, the at least one processor 510 may be configured to determine a tiny-open state based on sensing data of the optical sensor 521 in response to identifying the closed state of the door 31, 32, 33, or 34.

As an example, the at least one processor 510 may be configured to identify whether the sensing data of the optical sensor 521 is a level to be measured in a normal closed state.

As an example, the at least one processor 510 may be configured to determine when the sensing data of the optical sensor 521 fails to reach the level to be measured in the normal closed state as the tiny-open state.

As an example, the at least one processor 510 may be configured to collect sensing data regarding a distance change between the main body 10 and the door 31, 32, 33, or 34 for a predetermined time interval through the at least one sensor 520.

As an example, the at least one processor 510 may be configured to calculate a standard deviation by the collected sensing data.

As an example, the at least one processor 510 may be configured to determine reference data for determining a press on the outer surface based on the collected sensing data when the standard deviation is valid.

As an example, a method for operating a refrigerator 1 may comprise obtaining a distance change between a main body 10 and a surface of a door 31, 32, 33, or 34 that faces the main body 10 in a closed state in which the main body 10 and the door 31, 32, 33, or 34 substantially contact each other based on sensing data of at least one sensor 520, by at least one processor 510. The operation method may comprise determining a first press pattern of the door 31, 32, 33, or 34 based on the obtained distance change, by the at least one processor 510. The operation method may comprise identifying a first smart function corresponding to the determined first press pattern, by the at least one processor 510. The operation method may comprise performing control for providing the identified first smart function, by the at least one processor 510. The first press pattern may be determined by at least one of a first press count or first press duration in response to a press to an outer surface of the door 31, 32, 33, or 34.

Determining the first press pattern, by the at least one processor 510 may include obtaining a first number of times in which a sensing voltage level indicating the distance change reaches a predetermined first threshold for determining a press start.

As an example, determining the first press pattern, by the at least one processor 510 may include obtaining a second number of times in which the sensing voltage level reaches a predetermined second threshold for determining a press release.

As an example, determining the first press pattern, by the at least one processor 510 may include obtaining a press end as the sensing voltage level reaches a predetermined third threshold for determining a final press release.

As an example, determining the first press pattern, by the at least one processor 510 may include identifying the first press count based on the obtained first number of times and the obtained second number of times in response to the obtained press end.

As an example, determining the first press pattern, by the at least one processor 510 may include identifying the first press duration by a time interval between a first time of reaching the predetermined first threshold and a second time of reaching the second threshold in response to the obtained press end.

As an example, the operation method may comprise determining an open state or a closed state of the door 31, 32, 33, or 34 based on an output signal of the reed switch 523, by the at least one processor 510.

As an example, the operation method may comprise collecting sensing data corresponding to a distance between the main body 10 and the surface of the door 31, 32, 33, or 34 that faces the main body 10 through an optical sensor 521 included in the at least one sensor 520, by the at least one processor 510.

As an example, the operation method may comprise obtaining a standard deviation using the collected sensing data, by the at least one processor 510.

As an example, the operation method may comprise setting the predetermined first threshold and the predetermined second threshold considering the standard deviation, by the at least one processor 510.

As an example, the operation method may comprise obtaining a press change inside the main body 10 based on sensing data provided by a pressure sensor 525 included in the at least one sensor 520, by the at least one processor 510.

As an example, the operation method may comprise determining a second press pattern based on the obtained press change, by the at least one processor 510.

As an example, the operation method may comprise identifying a second smart function corresponding to the determined second press pattern, by the at least one processor 510.

As an example, the operation method may comprise performing control for providing the identified second smart function, by the at least one processor 510.

As an example, the second press pattern may be determined by at least one of a second press count or second press duration in response to a press to an outer surface of the door 31, 32, 33, or 34.

As an example, determining the first press pattern, by the at least one processor 510 may include identifying a press start on the outer surface based on the sensing data.

As an example, determining the first press pattern, by the at least one processor 510 may include identifying a press end on the outer surface based on the sensing data.

As an example, determining the first press pattern, by the at least one processor 510 may include detecting a final press by a standard deviation of the sensing data.

As an example, determining the first press pattern, by the at least one processor 510 may include obtaining the first press count considering the press start, the press end, and the final press.

As an example, determining the first press pattern, by the at least one processor 510 may include identifying a press start on the outer surface based on the sensing data.

As an example, determining the first press pattern, by the at least one processor 510 may include identifying a press end on the outer surface based on the sensing data.

As an example, determining the first press pattern, by the at least one processor 510 may include obtaining the first press duration by a time interval between a time of identifying the press start and a time of identifying the press end.

As an example, the operation method may comprise identifying a closed state of the door 31, 32, 33, or 34 by the reed switch 523, by the at least one processor 510.

As an example, the operation method may comprise determining a tiny-open state based on sensing data of an optical sensor 521 included in the at least one sensor 520 in response to identifying a closed state of the door 31, 32, 33, or 34, by the at least one processor 510.

As an example, determining the tiny-open state, by the at least one processor 510 may include identifying whether the sensing data of the optical sensor 521 is a level to be measured in a normal closed state.

As an example, determining the tiny-open state, by the at least one processor 510 may include determining when the sensing data of the optical sensor 521 fails to reach the level to be measured in the normal closed state as the tiny-open state.

As an example, the operation method may comprise collecting sensing data regarding a distance change between the main body 10 and the door 31, 32, 33, or 34 for a predetermined time interval through the at least one sensor 520, by the at least one processor 510.

As an example, the operation method may comprise calculating a standard deviation by the collected sensing data, by the at least one processor 510.

As an example, the operation method may comprise determining reference data for pressing a press on the outer surface based on the collected sensing data, by the at least one processor 510, when the standard deviation is valid.

The terms as used herein are provided merely to describe some embodiments thereof, but are not intended to limit the disclosure. As used herein, the singular forms “a,” “an,” and “the” are intended to include the plural forms as well, unless the context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, the term ‘and/or’ should be understood as encompassing any and all possible combinations by one or more of the enumerated items. As used herein, the terms “include,” “have,” and “comprise” are used merely to designate the presence of the feature, component, part, or a combination thereof described herein, but use of the term does not exclude the likelihood of presence or adding one or more other features, components, parts, or combinations thereof. As used herein, the terms “first” and “second” may modify various components regardless of importance and/or order and are used to distinguish a component from another without limiting the components.

As used herein, the terms “configured to” may be interchangeably used with the terms “suitable for,” “having the capacity to,” “designed to,” “adapted to,” “made to,” or “capable of” depending on circumstances. The term “configured to” does not essentially mean “specifically designed in hardware to.” Rather, the term “configured to” may mean that a device can perform an operation together with another device or parts. For example, a ‘device configured (or set) to perform A, B, and C’ may be a dedicated device to perform the corresponding operation or may mean a general-purpose device capable of various operations including the corresponding operation.

Meanwhile, the terms “upper side”, “lower side”, and “front and rear directions” used in the disclosure are defined with respect to the drawings, and the shape and position of each component are not limited by these terms.

In the disclosure, the above-described description has been made mainly of specific embodiments, but the disclosure is not limited to such specific embodiments, but should rather be appreciated as covering all various modifications, equivalents, and/or substitutes of various embodiments.

What is claimed is:

1. A home appliance, comprising:
a main body;
a door rotatably coupled to the main body;
a sensor configured to sense information about the door; and
a processor configured to:
based on the information sensed by the sensor, identify a state of the door,
in response to the identified state of the door being a closed state in which the main body and the door substantially contact each other,
based on the information sensed by the sensor, obtain changes in a distance between the main body and an inner surface of the door that faces the main body,
based on the obtained changes in the distance, determine at least one of a first press count or a first press duration,
based on the determined at least one first press count or first press duration, determine a first press pattern of the door, and
perform control to provide a smart function of the home appliance corresponding to the determined first press pattern.

2. The home appliance of claim 1, wherein the processor is further configured to:
obtain a first number of times in which a sensing voltage level indicating the obtained changes in the distance reaches a first threshold for determining a press start,
obtain a second number of times in which the sensing voltage level reaches a second threshold for determining a press release,
obtain a press end in which the sensing voltage level reaches a third threshold for determining a final press release, and
in response to the obtained press end,
based on the obtained first number of times and the obtained second number of times, identify the first press count, and
based on a time interval between a first time of the sensing voltage level reaching the first threshold and a second time of the sensing voltage level reaching the second threshold, identify the first press duration.

3. The home appliance of claim 2, wherein
the sensor includes a reed switch configured to sense information about the door and produce information corresponding to the sensed information, and
the processor is further configured to:
based on the information produced by the reed switch, identify the state of the door being an open state or the closed state.

4. The home appliance of claim 2, wherein
the sensor includes an optical sensor configured to sense information about the door and produce information corresponding to the sensed information, and
the processor is further configured to:
based on the information produced by the optical sensor, collect sensing data corresponding to the distance between the main body and the inner surface of the door,
obtain a standard deviation of the collected sensing data, and
set the first threshold and the second threshold based on the obtained standard deviation.

5. The home appliance of claim 1, wherein
the sensor includes a pressure sensor configured to sense a pressure inside the main body and produce corresponding data, and
the processor is further configured to:
based on the data produced by the pressure sensor, obtain a change in pressure inside the main body,
based on the obtained change in pressure, determine at least one of a second press count or a second press duration,
based on the determined at least one second press count or second press duration, determine a second press pattern of the door,
identify another smart function of the home appliance corresponding to the determined second press pattern, and
perform control to provide the identified another smart function.

6. The home appliance of claim 1, wherein
the processor is further configured to:
based on the information sensed by the sensor,
identify a press start corresponding to a start of a press on an outer surface of the door,
identify a press end corresponding to an end of the press on the outer surface,
based on a standard deviation of the information sensed by the sensor, detect a final press corresponding to a final press on the outer surface, and
based on the identified press start, the identified press end, and the detected final press, determine the first press count.

7. The home appliance of claim 1, wherein
the processor is further configured to:
based on the information sensed by the sensor,
identify a press start corresponding to a start of a press on an outer surface of the door,
identify a press end corresponding to an end of the press on the outer surface, and
based on the identified press start, the identified press end, determine the first press duration based on a time interval between a time of identifying the press start and a time of identifying the press end.

8. The home appliance of claim 1, wherein
the sensor includes:
an optical sensor configured to sense information about the door and produce first information corresponding to the information sensed by the optical sensor, and
a reed switch configured to sense information about the door and produce second information corresponding to the information sensed by the reed switch, and
the processor is further configured to:
based on the second information produced by the reed switch, identify the state of the door is the closed state, and
in response to the identified state of the door being the closed state, based on the first information produced by the optical sensor, determine the state of the door is a tiny-open state.

9. The home appliance of claim 8, wherein
the processor is further configured to:
identify whether the first information produced by the optical sensor corresponds to a level of the first information produced by the optical sensor with the state of the door being a normal closed state, and
based on the first information produced by the optical sensor failing to reach the level, determine the state of the door is the tiny-open state.

10. The home appliance of claim 1, wherein
the processor is further configured to:
collect the obtained changes in the distance for a predetermined time interval,
calculate a standard deviation of the collected changes in the distance, and
with the calculated standard deviation being valid, determine reference data for determining a press on an outer surface of the door based on the collected changes in the distance.

11. A method of operating a home appliance including a main body, a door rotatably coupled to the main body, a sensor configured to sense information about the door, and a processor, the method comprising:
by the processor,
based on the information sensed by the sensor, identifying a state of the door,
in response to the identified state of the door being a closed state in which the main body and the door substantially contact each other,
based on the information sensed by the sensor, obtaining changes in a distance between a main body and an inner surface of the door that faces the main body,
based on the obtained changes in the distance, determining at least one of a first press count or a first press duration,
based on the determined at least one first press count or first press duration, determining a first press pattern of the door,
identifying a smart function of the home appliance corresponding to the determined first press pattern, and
performing control to provide the identified smart function.

12. The method of claim 11, wherein
the determining the first press pattern includes:
obtaining a first number of times in which a sensing voltage level indicating the obtained changes in the distance reaches a first threshold for determining a press start,
obtaining a second number of times in which the sensing voltage level reaches a second threshold for determining a press release,
obtaining a press end in which the sensing voltage level reaches a third threshold for determining a final press release, and
in response to the obtained press end,
based on the obtained first number of times and the obtained second number of times, identifying the first press count, and
based on a time interval between a first time of the sensing voltage level reaching the first threshold and a second time of the sensing voltage level reaching the second threshold, identifying the first press duration.

13. The method of claim 12, wherein
the sensor includes a reed switch configured to sense information about the door and produce information corresponding to the sensed information, and
the identifying the state of the door includes:
based on the information produced by the reed switch, identifying the state of the door being an open state or the closed state.

14. The method of claim 12, wherein
the sensor includes an optical sensor configured to sense information about the door and produce information corresponding to the sensed information, and
the method further includes:
by the processor,
based on the information produced by the optical sensor, collecting sensing data corresponding to the distance between the main body and the inner surface of the door,
obtaining a standard deviation of the collected sensing data, and
setting the first threshold and the second threshold based on the obtained standard deviation.

15. The method of claim 11, wherein
the sensor includes a pressure sensor configured to sense a pressure inside the main body and produce corresponding data, and
the method further includes:
by the processor,
based on the data produced by the pressure sensor, obtaining a change in pressure inside the main body,
based on the obtained change in pressure, determining at least one of a second press count or a second press duration,
based on the determined at least one second press count or second press duration, determining a second press pattern of the door,
identifying another smart function of the home appliance corresponding to the determined second press pattern, and
performing control to provide the identified another smart function.

16. The method of claim 11, wherein
the determining the first press pattern includes:
by the processor,
based on the information sensed by the sensor,
identifying a press start corresponding to a start of a press on an outer surface of the door,
identifying a press end corresponding to an end of the press on the outer surface,
based on a standard deviation of the information sensed by the sensor, detecting a final press corresponding to a final press on the outer surface, and
based on the identified press start, the identified press end, and the detected final press, determining the first press count.

17. The method of claim 11, wherein
the determining the first press pattern includes:
by the processor,
based on the information sensed by the sensor,
identifying a press start corresponding to a start of a press on an outer surface of the door,
identifying a press end corresponding to an end of the press on the outer surface, and
based on the identified press start and the identified press end, determining the first press duration based on a time interval between a time of identifying the press start and a time of identifying the press end.

18. The method of claim 11, wherein
the sensor includes:
an optical sensor configured to sense information about the door and produce first information corresponding to the information sensed by the optical sensor, and
a reed switch configured to sense information about the door and produce second information corresponding to the information sensed by the reed switch, and
the identifying the state of the door includes:
based on the second information produced by the reed switch, identifying the state of the door is the closed state, and
the method further includes:
by the processor,
in response to the identified state of the door based on the second information being the closed state, based on the first information produced by the optical sensor, determining the state of the door is a tiny-open state.

19. The method of claim 18, wherein
the determining the tiny-open state includes:
identifying whether the first information produced by the optical sensor corresponds to a level of the first information produced by the optical sensor with the state of the door being a normal closed state, and
based on the first information produced by the optical sensor failing to reach the level, determining the state of the door is the tiny-open state.

20. The method of claim 11, further comprising:
by the processor,
collecting the obtained changes in the distance for a predetermined time interval,
calculating a standard deviation of the collected changes in the distance, and
with the calculated standard deviation being valid, determining reference data for determining a press on an outer surface of the door based on the collected changes in the distance.
